(19) United States
(12) Patent Application Publication
(10) Pub. No.: US 2002/0150248 A1
(43) Pub. Date: Oct. 17, 2002

(54) System for digital stream reception via memory buffer and method thereof

(76) Inventor: Branko D. Kovacevic, Toronto (CA)

Correspondence Address: SIMON, GALASSO & FRANTZ PLC, P.O. BOX 26503, AUSTIN, TX, 78755-0503, US

(21) Appl. No.: 09/956,721

(22) Filed: Sep. 20, 2001

Related U.S. Application Data
(60) Provisional application No. 60/273,737, filed on Mar. 6, 2001.

(51) Int. Cl. H04N 7/167

(52) U.S. Cl. 380/210

(57) ABSTRACT

Systems and a method are described for providing protected video data to a video decoder. A network interface module receives an encrypted multimedia transport stream. The network interface module decrypts the protected multimedia transport stream. The multimedia transport stream is then re-encrypted using an encryption scheme known by a video decoder. The re-encrypted multimedia transport stream is sent to a video decoder over a peripheral component interconnect data bus. The video decoder decrypts the re-encrypted multimedia transport stream and processes video and audio data associated with the multimedia transport stream.

### FIELD OF THE DISCLOSURE

The present invention relates generally to digital stream reception and more particularly to protecting digital streams.

### BACKGROUND

To handle specific tasks, such as video and audio processing, many information handling systems allow peripheral hardware devices to be integrated with the system through a system bus. For example, most information handling systems include a peripheral component interconnect (PCI) bus for interfacing several devices with a local bus of the information handling system. A PCI interface may be used for attaching peripheral devices to the information handling system. In many system motherboards, a primary PCI bus is internal to the information handling system and used for local hardware components. Peripheral devices connect to PCI expansion ports that are located on a secondary PCI bus, separate from the primary, or local PCI bus. The secondary PCI bus is connected to the primary PCI bus through a PCI bridge device.

Transactions dealing with peripheral devices connected through PCI expansion ports must go through the PCI bridge device. Peripheral devices have no direct link with the primary PCI bus. The PCI bridge device may include a buffer to capture a transaction and let the transaction finish before the transaction actually completes at an intended destination. A source of data may then proceed with the next operation while the transaction is still making its way through the system to its final and ultimate destination; however, the transaction capture complicates event ordering because other events that the programmer intended to happen after a write transaction may happen before the write transaction is actually competed at its final destination.

A solution is to use communication between a data producer and a data consumer. The system architecture shown in prior art FIG. 1 allows the data 120, the flag element 170, the status element 160, the data producer, producer 180, and the data consumer, consumer 110, to reside anywhere in a system. Flag element 170 and the status element 160 may be positioned on primary PCI bus 150, on the side of producer 180, while data 120 and consumer 110 may reside on secondary PCI bus 130. In such a case, producer 180 initiates a data access by writing a set of data. A PCI-to-PCI bridge, bridge 140, between PCI buses 130 and 150, completes the data access associated with the set of data by posting the set of data to data 120. The producer 180 sets flag element 170, indicating that the set of data being written is now valid for consumer 110 to use. When consumer 110 reads the flag element 170, bridge 140 flushes the posted data to the final destination before allowing the read cycle of consumer 110 to flag element 170 to complete. When the consumer 110 finds flag element 170 is set, the set of data is actually known to be valid at the final destination. Producer 180 may also poll a status element 160 to determine that one set of data is consumed and that the system is able to accept a new set of data. Peripheral data buses, such as secondary data bus 130, allow various peripheral devices to be integrated with a system; however, data sent along the peripheral data bus is exposed to external probing, or tapping.

Data provided to system components external to the information handling system may need to be protected. When receiving a data stream from a digital video broadcasting system or from a digital storage media, the received stream must be encrypted to satisfy copy protection or pay-per-view specification needs. The broadcast industry and content producers do not allow any decoder architecture that exposes a single or multiple program multiplexed data stream on any connector or inter-chip parallel or serial bus where unauthorized stream access can occur. A current solution to this problem requires an embedded stream descrambler integrated with a stream decoder used to decode the stream data, in order to carry encrypted stream on interconnection systems. This requirement poses a serious problem to a stream decoder with no built-in descrambler, limiting a widespread use of such a decoder system (decoder with no embedded stream descrambling unit).

Some solutions are based on an external descrambling engine and the use of proprietary serial or a parallel data buses to carry in a decrypted data stream towards the stream decoder. Those solutions are usually deployed in small, private broadcast networks because the film industry considers the data busses to the stream decoder vulnerable against a highly motivated pirate who could tap and tape the decrypted data stream. Other solutions use an internal descrambling engine, but internal scrambling engines are cost ineffective because they usually need to support multiple encryption standards, (to have a high market penetration). In addition, the engines useful lifetime is limited, as they become obsolete when a new decryption standard evolves. From the above discussion it is apparent that an improved method of processing received protected data streams.

### BRIEF DESCRIPTION OF THE DRAWINGS

Specific embodiments of the present invention are shown and described in the drawings presented herein. Various objects, advantages, features and characteristics of the present invention, as well as methods, operations and functions of related elements of structure, and the combination of parts and economies of manufacture, will become apparent upon consideration of the following description and claims with reference to the accompanying drawings, all of which form apart of this specification, and wherein:

FIG. 1 is a block diagram illustrating a prior-art system for handling data transactions between a primary and a secondary PCI bus using a PCI bridge;

FIG. 2 is a block diagram illustrating a system for handling received protected data streams, according to one embodiment of the present invention;

FIG. 3 is a flow diagram illustrating a method of handling protected data streams, according to one embodiment of the present invention;

FIG. 4 is a block diagram illustrating components of MPEG and analog video decoder within 2D/3D graphics accelerator, according to one embodiment of the present invention; and

FIG. 5 is a block diagram illustrating an integration of a data stream descrambler within MPEG and analog video decoder and 2D/3D graphics accelerator, according to one embodiment of the present invention.

### DETAILED DESCRIPTION OF THE FIGURES

An embodiment of the present invention provides for a method of transferring protected multimedia data. The method includes receiving a protected data stream that is scrambled using a first encryption scheme. Scrambling is a method of protecting a digital data stream by encoding or encrypting the digital data stream using an encryption algorithm or scheme. The protected data stream is then decoded to generate an unscrambled data stream. The method also includes scrambling the decoded data stream using a second encryption scheme to generate a re-scrambled data stream. The second encryption scheme is different from the first, and is selected to match an encryption scheme used by a data decoder, such as MPEG video decoder. The method further includes providing the re-scrambled data stream to the data decoder. The data decoder may then unscramble the re-scrambled data stream.

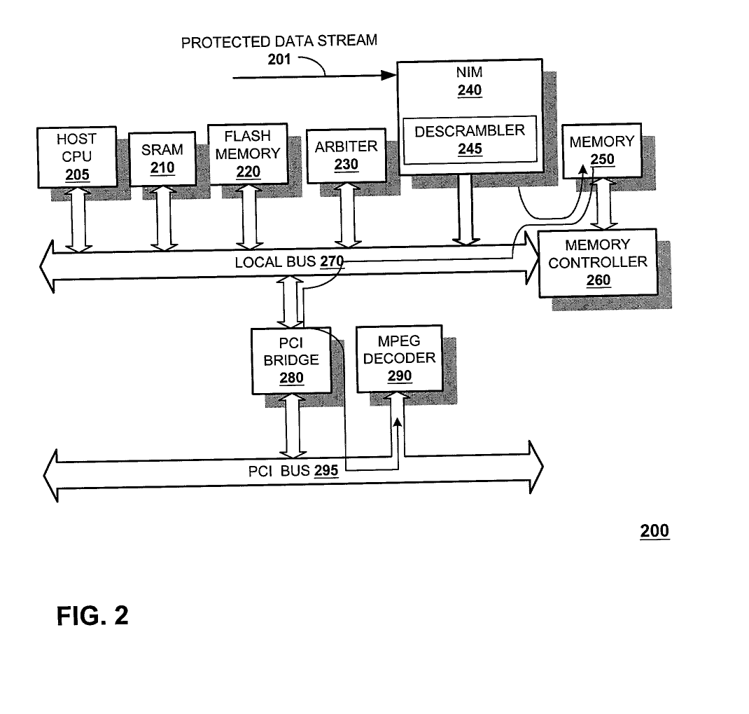

Referring now to FIG. 2, a block diagram illustrating a system for handling received protected data streams is shown and generally referenced as system 200, according to one embodiment of the present invention. A network interface module (NIM) 240, interfaced directly with a local bus 270 of system 200, decrypts protected data stream 201. In one embodiment, NIM 240 stores the unencrypted digital stream in memory 250. The unencrypted digital stream stored in memory 250 is re-encrypted in place by a host central processing unit (CPU) 205 and placed back in memory 250. An MPEG decoder 290 may then read the re-encrypted digital data through a peripheral system bus, PCI bus 295.

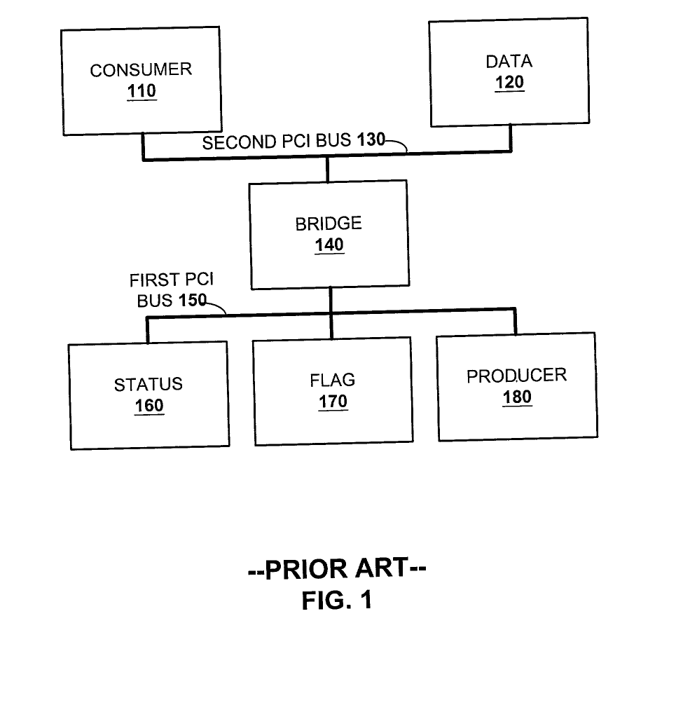

System 200 includes a primary data bus, local bus 270 and a secondary bus, PCI bus 295. In one embodiment, local bus 270 is internal to system 200 and is not directly accessible to peripheral devices connected to system 200. Access to local bus 270 may be restricted to only components interfaced directly with system 200, such as static random access memory (SRAM) 210, flash memory 220, local bus arbiter 230, NIM 240, memory controller 260, and PCI bridge 280. Local bus 270 may be considered secure in that access to data passing through local bus 270 is inaccessible to external probing. External probing refers to a person attempting to read data passing through portions of system 200, such as PCI bus 295, using a signal probe or hardware device connected to system 200. Peripheral hardware devices, such as Motion Pictures Experts Group (MPEG) decoder 290, which are to be interfaced with system 200 may be connected to PCI bus 295. A PCI bridge 280 provides an interface between local bus 270 and PCI bus 295, allowing the peripheral devices to communicate with internal hardware of system 200. In one embodiment, PCI bridge 280 handles communications between buses 270 and 295 as described in reference to prior art FIG. 1. A peripheral device, such as MPEG decoder 290, polls a flag set in an alternate device, or in memory, such as in SRAM 210, to determine if needed data has been fully passed to a destination peripheral device. PCI bridge 280 ensures that the data has been completely transferred before allowing a read access of the flag to be completed.

In one embodiment, system 200 includes memory devices, such as SRAM 210 and flash memory 220, interfaced directly with local bus 270. SRAM 210 and flash memory 220 may be used to store data associated with an encryption scheme. System 200 may also include a memory controller 260 for providing access to system memory, such as memory 250. A local bus arbiter 230 may be used to arbitrate among various memory requests sent along local bus 270. Local bus arbiter 230 may be used to select requests to submit to memory controller 260 from among the memory requests placed on local bus 270. In one embodiment, the local bus arbiter selects among the memory requests to ensure that requests that are dependent on other requests being processed are processed in an appropriate order. Local memory arbiter 230 may provide memory requests to memory controller 260 to allow the memory requests to be efficiently handled through memory 250. In one embodiment, local memory arbiter 230 ensures that requests associated with current open memory pages are processed while the page is still open to avoid delays associated with memory page hits. In another embodiment, local bus arbiter 230 selects from the memory requests in a round robin fashion in which a single request from each of available memory requesters is selected in turn, as in a round-robin configuration.

A data stream receiver, such as NIM 240, provides an input interface for system 200, receiving protected data stream 201 for system 200. NIM 240 includes a descrambler 245 for unscrambling, or decoding, encrypted data of protected digital stream. In one embodiment, protected data stream 201 is encoded with an encryption algorithm, such as through data encryption standard (DES), digital video broadcasting (DVB) standards, or a proprietary encryption standard. Descrambler 245 is used to decrypt the protected data stream 201 according to the encryption standard selected. In one embodiment, NIM 240 stores data decrypted by descrambler 245 in memory 250, through local bus 270 and memory controller 260. Descrambler 245 matches the standard used to encrypt protected data stream 201. If the encryption standard used to encrypt protected data stream 201 is changed, the decryption standard used by descrambler 245 must also be changed. In one embodiment, NIM 240 is replaced with a new NIM module to match the encryption standards used to encrypt protected data stream 201. In another embodiment, a descrambler 245 is replaced to match the new decryption standard needed. Alternatively, a firmware associated with NIM 240 may be updated to match the decryption standard needed.

It should be noted that different types of NIM 240 may be used for receiving different types of digital data streams, such as protected data stream 201, without departing from the scope of the present invention. For example, NIM 240 may include a cable demodulator supporting quadrature amplitude modulation (QAM)-64 and -256, a terrestrial demodulator supporting Vestigial Side Band (VSM)-8 and -16 modulation, and orthogonal frequency division multiplexing, or a satellite quadrature phase shift keying (QPSK) modulation. NIM 240 may also include digital data stream receiver for receiving digital data through an asynchronous transfer mode (ATM) network, IEEE 1394 (firewire) interface, digital cable interface, digital satellite interface, or a video conferencing interface.

In one embodiment, once the descrambled data associated with protected data stream 201 has been placed in memory 250, host CPU 205 may be used to re-encrypt the data according to a second encryption scheme, different from the first encryption scheme used to encrypt protected data stream 201. For example, an application program in system 200 may provide instructions to host CPU 205 for re-encrypting the unscrambled digital data to DES encrypted data. Host CPU 205 is used to encrypt the data according to an encryption standard expected by MPEG decoder 290. In one embodiment, once the data has been re-encrypted by host CPU 205, host CPU 205 places the re-encrypted data back in memory 250. Once the data is stored, host CPU 205 may be used to send a command to MPEG decoder 290 indicating the data is ready for transfer over PCI bridge 280. In one embodiment, multiple buffers are arranged in memory 250 to store multiple sets of data. Host CPU 205 provides an indication to MPEG decoder 290 that data in a first buffer is ready for transfer. While MPEG decoder 290 begins to receive the data from the first buffer, host CPU 205 may re-encrypt data in the second buffer. While the discussion provided describes a method of re-encrypting descrambled data using host CPU 205, it should be noted that NIM 240 may also be used to re-encrypt data descrambled from protected data stream 201. Data unscrambled using descrambler 245 may be re-encrypted using an encryption component (not shown) of NIM 240. NIM 240 may then store the re-encrypted data stream in memory 250.

Once MPEG decoder 290 receives the indication from host CPU 205 that the data is ready for transfer, MPEG decoder submits commands to PCI bridge 280 to transfer the data from memory 250, through local bus 270, to MPEG decoder 290 through PCI bus 295. MPEG decoder 290 may be used to decode the re-encrypted data. In one embodiment, MPEG decoder 290 includes a decryption component (not shown) for decoding the data transferred from memory 250. The type of decryption component used by MPEG decoder 290 should match the type of encryption performed by host CPU 205, or NIM 240. It should be noted that data is not allowed to be unprotected over PCI bus 295. The data must be encrypted before being passed along PCI bus 295, ensuring unprotected data is not directly accessible through PCI bus 295. In one embodiment, MPEG decoder 290 includes a DES decryption component to decode data encrypted by host CPU 205 using DES encryption methods. It should be appreciated that other methods of encryption and decryption may also be used. While DES encryption and decryption schemes are referenced herein, it should be appreciated that other encryption schemes may be used without departing from the scope of the present invention. Other encryption schemes may include, but are not limited to, pretty good privacy (PGP), Rivest-Shamir-Adleman (RSA), elliptic curve encryption, etc. In at least one embodiment, the encryption scheme used includes an encryption algorithm based on an encryption/decryption key. While an MPEG decoder 290 has been described, it should be noted that other data decoders may also be used, such as audio decoders, without departing from the scope of the present invention.

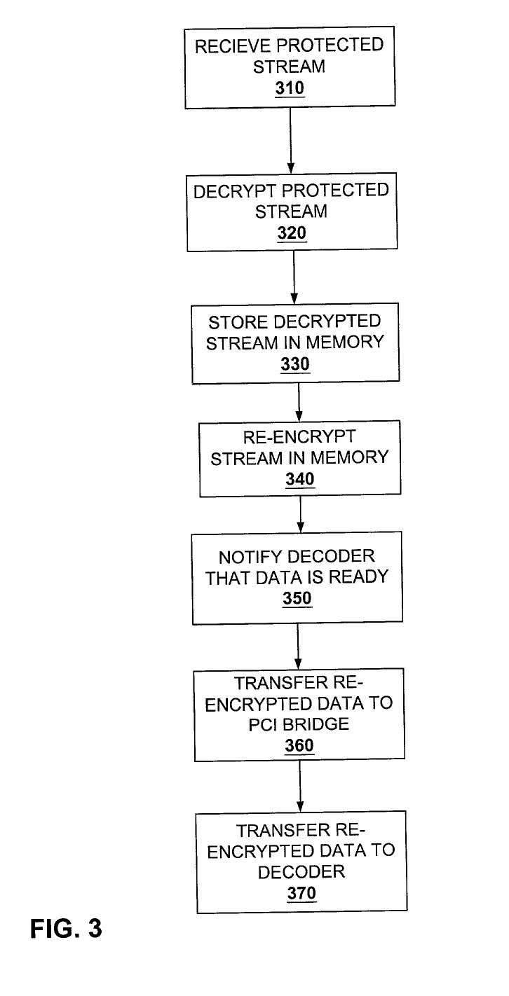

Referring now to FIG. 3, a flow diagram illustrating a method of handling protected data streams is shown, according to one embodiment of the present invention. Received video data, which has been protected with a first encryption standard, is decrypted and re-encrypted with an encryption standard known by a data decoder, such as an integrated video decoder. The re-encrypted data is transferred over an exposed data bus to the video decoder, which internally decrypts the data and processes it into image data.

In step 310, a data stream receiver receives a protected video stream. The data receiver is interfaced directly with a local bus of an information handling system. In one embodiment, the data receiver is a NIM module designed to receive a video data stream. As previously discussed, the protected video stream may include digital cable video data, satellite video data, and such. The protected video stream is associated with video data encrypted using a first encryption standard. The encryption standard may include DES, DVB, or a form of proprietary encryption.

In step 320, the data receiver decrypts the protected video stream according to the first encryption standard. In step 330, decrypted data, associated with the protected video stream, is stored in memory. In one embodiment, the decrypted data is passed to memory through the local bus. The local bus is internal to the information handling system and is not publicly exposed. The local bus is not generally accessible to external probing. Access to the local bus by a device external to the information handling system is handled through a PCI bridge.

In step 340, at least a first portion of the decrypted data stored in memory is re-encrypted using a host CPU of the information handling system. The host CPU is used to encrypt the decrypted data according to a second encryption standard. In one embodiment, the second encryption standard is to be used by both the host CPU and a peripheral video decoder. Accordingly, the video decoder may decrypt data encrypted by the host CPU. In step 350, once the host CPU has completely re-encrypted at least the first portion of the decrypted data, the host CPU notifies the video decoder that the first portion of re-encrypted data is ready for transfer. In another embodiment, the NIM module is used to re-encrypt the decrypted data.

In step 360, the re-encrypted data is transferred from memory to a PCI bridge. As previously discussed, the PCI bridge provides a gateway between the local bus internal to the information handling system, and the PCI bus used for interfacing peripheral components to the information handling system. In one embodiment, the host CPU sets a flag stored in memory on the local bus to indicate the data has been sent. In step 370, the PCI bridge begins to transfer the data to the video decoder. The video decoder may submit a read request, through the PCI bridge, to determine if the flag has been set. Before allowing the read request to complete, the PCI bridge ensures the data has been fully transferred to the video decoder. Once the video decoder has received all the first portion of the re-encrypted data, the video decoder decrypts the data. The data is decrypted according to the standard used by the host CPU to re-encrypt the data. Once the video data has been decrypted, the data may process the data. In one embodiment, the video data is processed for presentation on a display device.

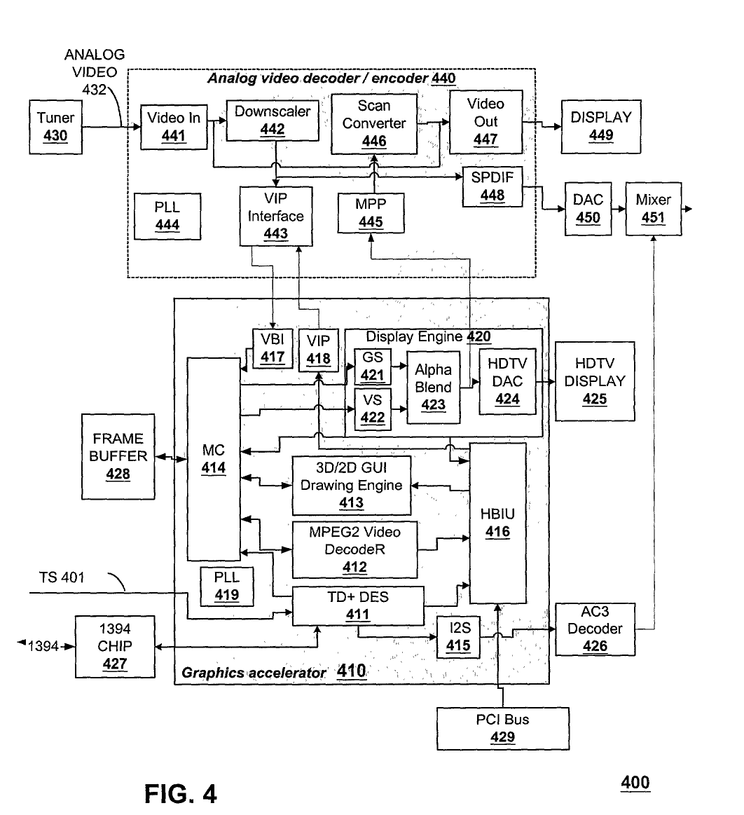

Referring now to FIG. 4, a block diagram illustrating components of a video decoder is shown and referenced generally as video decoder system 400, according to one embodiment of the present invention. A data decoder, such as graphics accelerator portion 410, is used to receive encrypted digital video data from PCI bus 429. The encrypted digital data is decrypted and processed into displayable video data. An analog video decoder portion 440 is used to receive analog video 432 from an analog tuner 430. Analog and digital video data may be processed for display through video decoder 400.

Graphics accelerator portion 410 receives and processes digital video streams sent through PCI bus 429. In one embodiment, a NIM (not shown) is used to receive a protected digital stream from a broadcasting source. The NIM unscrambles the protected digital stream to generate an unencrypted video stream. The unencrypted video stream is then re-encrypted using an encryption algorithm known by graphics accelerator portion 410. The re-encrypted video stream is sent to graphics accelerator portion 410 through PCI bus 429. A host bus interface unit (HBIU) 416 of graphics accelerator portion 410 provides an interface to PCI bus 429. Graphics accelerator portion 410 includes components to decrypt the re-encrypted video stream, such as transport demultiplexer and DES processing component 411. Unencrypted video stream data is then provided to components of graphics accelerator 410 for processing. In one embodiment, HBIU 416 has address re-mapping capabilities and byte order conversion. To allow video decoder 400 to be used in a wide variety of systems, HBIU 416 may be used to remap addresses provided through PCI bus 429. HBIU may provide byte conversion of data received and passed to PCI bus 429, such as little-to-big Endian conversion, and vice-versa.

Components of graphics accelerator 410 are used to process unencrypted digital video data. Video data provided through HBIU 416 may be stored in a frame buffer 428, through memory controller 414. Commands to be processed by graphics accelerator portion 410 and video textures may be provided to the GUI drawing engine 413. Memory controller 414 handles access requests for frame buffer 428 from various components, such as a transport demultiplexer 411, an MPEG2 video decoder 412, and GUI drawing engine 413. MPEG2 video decoder 412 is used to decode video data into displayable image data according to the MPEG-2 standards specification.

A transport demultiplexer and DES processing component 411 processes video data from a transport stream 401. In one embodiment (not illustrated), the transport stream 401 is received through host bus interface unit 416. Alternatively, transport stream 401 may be provided through an external source. Transport demultiplexer and DES processing component 411 decrypts transport stream 401 to generate unencrypted video data. Transport demultiplexer and DES processing component 411 then demultiplexes the decrypted transport stream data to generate individual packetized elementary streams (PES) for individual processing. In one embodiment, broadcast information, such as MPEG channel navigation and electronic program guide information is also decoded from within transport stream 401. Video data may be stored in frame buffer 428, through memory controller 414. In one embodiment, frame buffer 428 includes an 8-to 16-megabyte, 64-bit, 125 MHz memory buffer. It should be appreciated that other frame buffers may be used. Video data may also be received/sent from/to an external source through an IEEE 1394 (firewire) interface chip 427. Audio data selected through transport demultiplexer and DES processing component 411 may be provided to an I2S component 415. I2S component may format audio data for output through an audio codec-3 (AC3) decoder 426. A phase-locked loop (PLL) component 419 may be used for synchronizing video and audio processing to an external clock for presenting multimedia data.

An analog video decoder portion 440 is used for processing analog video data. Analog video 432 is received from an analog tuner 430 through a video input port 441. A PLL component 444 is used to synchronize operations within analog video decoder 440. A video interface port (VIP) interface 443 is used to transfer data between analog video decoder portion 440 and graphics accelerator portion 410. VIP interface 443 is an open, non-proprietary standard interface used for transferring data between video and graphics devices. In one embodiment, data passed through the vertical blanking interval (VBI), VBI data, of analog video 432 is passed to a video/NBI component 417 of graphics accelerator portion 410. In another embodiment, video data digitized from analog video 432 is also passed to video/VBI 417 for storage in frame buffer 428, through memory controller 414. Data may also be passed from graphics accelerator portion 410 to VIP interface 443, through a VIP interface 418 of graphics accelerator portion 410.

A display engine 420 of graphics accelerator portion 410 is used to process digital video data for output. A graphics scaler 421 is used to scale image data associated with system graphics. A video scaler 422 is used to scale image data associated with video data. In one embodiment, the video data includes digital video data associated with analog video 432 processed through analog video decoder portion 440. Video and graphics image data are combined through an alpha blend module 423. A high-density television (HDTV) digital-to-analog converter 424 is used to generate analog video data associated with the image data for display on an HDTV monitor 425.

In one embodiment, analog video decoder portion 440 is also capable of outputting video to a display. A downscaler 442 and a scan rate converter 446 are used to format analog video data for presentation through an analog video output port 447. A multimedia peripheral port (MPP) interface 445 is used to provide video data processed through display engine 420 to scan converter 446. Accordingly, scan converter 446 may combine the video data from MPP interface 445 with analog video associated with analog video 432 for display, such as in a picture-in-picture format. Using a picture-in-picture format, one video would represent a primary video source taking the majority of a display screen while the other video would be presented in a smaller portion of the display screen. In one embodiment, MPP interface 445 is a bi-directional port for transferring video data between video and graphics devices. Analog video output 447 provides analog video to an analog display 449. In one embodiment, analog video output 447 is used to insert VBI data with the analog video being output.

Digital audio data is processed through a Sony-Phillips digital interface (SPDIF) 448 for output through an audio DAC interface 450. Audio mixer 451 may be used to mix audio output through audio DAC 450 and AC3 decoder 426. Audio data may then be output through Audio mixer 451 to an audio receiver (not shown) or set of audio speakers (not shown). It should be noted that video decoder system 400 has the capability of combining graphics image data with analog or digital video data for output to a display. Video decoder system 400 is also capable of processing and inserting VBI data.

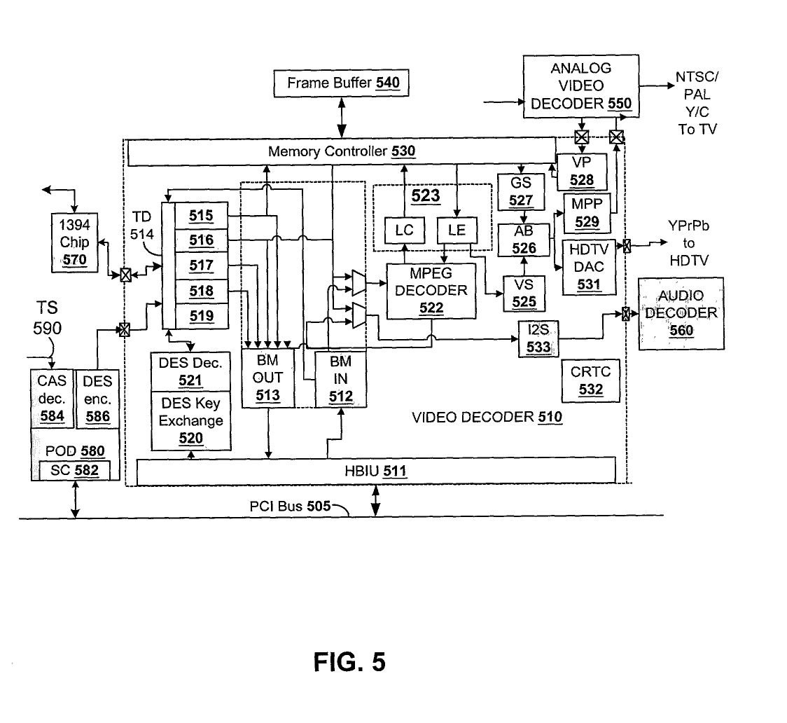

Referring now to FIG. 5, a block diagram illustrating an integration of a data stream descrambler within a digital video decoder 510 is shown, according to one embodiment of the present invention. A digital video decoder 510 is used to decrypt and decode multimedia data associated with an encrypted transport stream. A protected transport stream is decrypted according to a first encryption standard and re-encrypted with a second encryption standard. The digital video decoder 510 includes a decryption component, such as DES decryptor 521, to decrypt the re-encrypted transport stream according to the second encryption method.

HBIU 511 is used to receive a re-encrypted transport stream through PCI bus 505. In one embodiment, bus master input module 512 and bus master output module 513 handle bus mastered communications through PCI bus 505. As previously discussed, an encrypted transport stream received through PCI bus 505 is received and decrypted in a NIM module (not shown) of a system connected to PCI bus 505 through a PCI bridge 280 (FIG. 2). The transport stream is then re-encrypted for transfer over PCI bus 505. The received re-encrypted transport stream is passed to a transport demultiplexer 514. DES decryptor 521 is used to decrypt the re-encrypted transport stream passed to the transport demultiplexer 514. A DES key exchange module 520 is used to update a current DES decryption key being used by DES decryptor 521.

In one embodiment, digital video decoder 510 is also capable of receiving a transport stream 590, through a point of deployment (POD) module 580. POD module 580 is a security module used for receiving various transport streams protected through a conditional access system (CAS). CAS allows different transport streams to be encrypted using different conditional access keys. A user provides a smartcard 582 for interface with POD module 580. Smartcard 582 includes conditional access keys for receiving particular programs from transport stream 590. Smartcard 582 may also be updated through PCI bus 505 for receiving new programs, such as for pay-per-view events.

In one embodiment, POD module 580 operates according to a copy protection scheme as described in the OpenCable POD-Copy Protection specification. POD module 580 is a method of providing a copy protection that may be updated as necessary. Systems that use POD modules, such as POD module 580, may be upgraded to match copy protection schemes of different digital cable systems by either replacing POD module 580 or by using a different smartcard 582. Accordingly, the system may also be upgraded if a new copy protection standard needs to be used for security reasons. Different cable subscribers may also update a system with their access information by inserting their smartcard 582 into POD module 580. In one embodiment, copy protection techniques are designed to meet standards defined by the Dynamic Feedback Arrangement Scrambling Technique (DFAST) specifications.

A CAS decryptor 584 is used to decrypt transport stream 590. POD module 580 also includes a DES encryptor 586 to re-encrypt the transport stream, for transfer to digital video decoder 510. To meet DFAST robustness rules, DES decryptor 521 must pass the copy protection key used by POD module 580 over PCI bus 505 in an encrypted form. In one embodiment, a 56-bit Diffie-Hellman algorithm is used to calculate a bus encryption key. The bus encryption key is used to encrypt the copy protection key. In one embodiment, the bus encryption key is refreshed every time POD module 580 or a bus-mastering agent refreshes the copy protection key. The transport stream scrambled by DES encryptor 586 is passed to transport demultiplexer 614. Transport demultiplexer 514 selects a particular program from the scrambled transport stream and DES decryptor 621 is used to descrambler the selected program. It should be noted that while the discussion provided here refers to specific standards of copy protection and encryption, other standards may be also be employed without departing from the scope of the present invention. In one embodiment, an IEEE 1394 interface chip 570 is also used to receive and provide multimedia data received through a firewire interface.

Once descrambled, transport demultiplexer 514 provides the transport stream data to a set of parsers 515-519, which parse particular portions of the transport stream data. A video packetized elementary stream (PES) parser 515 selects particular video PES sets of data. An audio PES parser 516 provides audio PES data. A transport packet parser 517 provides particular transport packets. A section field parser 518 provides section field data. A system time clock (STC) parser 519 provides STC information available in the transport packet. Transport packet data may be stored in frame buffer 540 through memory controller 530. An MPEG decoder 522 may be used to decode video data to generate displayable image data, according to MPEG specifications. Decoded MPEG data may be stored in frame buffer 540, through memory controller 530. In one embodiment, lossy compression components 523 are used to store and retrieve video data stored in frame buffer 540. Lossy compression involves doing DCT transform on block of 8 pixels. DCT transform requires 16 bit precision, the coefficient are then rounded to 9 bit precision. Decompression involves reversing the sequence of processes to reconstruct the pixels. This way, the storage requirements for MPEG decoder (the size of temporal memory for I, B, P pictures) are reduced significantly.

A graphics scaler 527 may be used to scale image data associated with system graphics. A video scaler 525 may be used to scale image data associated with digital video data. In one embodiment, an alpha blend module 526 is used to combine graphics and video image data for display. Video from the alpha blend module 526 may be output through an HDTV DAC component 531. HDTV DAC component 531 generates analog video signals for display on an HDTV display device (not shown). Video from alpha blend module 526 may also be output to an analog video decoder 550 through an MPP port 529.

Analog video decoder generates video signals for display on an analog television display (not shown). In one embodiment, analog video decoder 550 also receives and digitizes video data from an analog video source (not shown), such as a broadcast analog television tuner. Video received and processed through analog video decoder 550 may also be passed to digital video decoder 510 through a video capture component 528. The video data received through video capture component 528 may be stored in frame buffer 540, for combination with other image data processed through digital video decoder 510.

An I2S component 533 is used to format digital audio data for output to an audio decoder 560. Audio decoder 560 may be used to process the digital audio data to analog audio data for output to audio speakers or an audio receiver. A cathode ray tube controller (CRTC) 532 is used to generate appropriate signals for synchronizing video data for presentation on a display device. For example, CRTC 532 may be used to generate signals to generate vertical and horizontal retraces on an external display device. In one embodiment, various registers are used for controlling processing performed through digital video decoder 510, as shown in the following table, Table 1.

TABLE 1
System Registers

| Field Name | Bits | Default | Description |
|---|---|---|---|
| TD_PODCP_KEY_PAIR_31_0 | 31:0 | 0 × 0 | even/odd keys corresponding to |
| | | | 0 video, 1 audio, 2-31 joint PIDs 0-29 |
| TD_PODCP_KEY_PAIR_63_32 | 31:0 | 0 × 0 | Odd/even keys 32-63 for section |
| | | | filters 0-31 |
| BYPASS_PODCP | 0 | 0 × 1 | Set to 1 to bypass internal decryptor. |
| PASSTHROUGH_OVERRIDE | 0 | 0 × 0 | Passes all transport stream data |
| | | | through the DES cipher unaltered. |
| ENCRYPT | 1 | 0 × 0 | Selects between encrypting and |
| | | | decrypting transport streams that have |
| | | | the scramble_control bits set to ‘10’ |
| | | | and ‘11’. |
| KE_RESET | 2 | 0 × 0 | Resets the cryptographic key |
| | | | exchange process. |
| KE_CALCULATE | 3 | 0 × 0 | Enables the cryptographic key |
| | | | exchange process. It will be cleared |
| | | | automatically when the CP Key has |
| | | | been flopped. |
| KE_STAGE (R) | 6:4 | 0 × 0 | Indicates the stage of the key |
| | | | exchange process. |
| KEY_PAIR | 7 | 0 × 0 | Selects the key pair destination of CP |
| | | | Key writes. |
| ODD_EVEN | 8 | 0 × 0 | Selects the parity destination of CP |
| | | | Key writes. |
| WAIT_STATES | 11:9 | 0 × 3 | Number of clocks between output |
| | | | requests to the Transport Demux. This |
| | | | should be left at the default. |
| LSB_FIRST | 12 | 0 × 0 | Selects how to interleave data bytes to |
| | | | form the QWORD input to the DES |
| | | | cipher. |
| DATA_IN_OVERRUN | 13 | 0 × 0 | Indicates that data input to the DES |
| | | | cipher has been overrun. This will |
| | | | result in data corruption. |
| DATA_OUT_OVERRUN | 14 | 0 × 0 | Indicates that the data output to the |
| | | | Transport Demux has been overrun. |
| | | | This will result in data corruption but |
| | | | may be remedied by reducing the |
| | | | value in the WAIT_STATES field. |
| CP_KEY_EXCHANGE | 15 | 0 × 0 | Selects the type of CP Key exchange |
| | | | between the CPU and the MPEG |
| | | | decoder. |
| REG_TEST_ENABLE | 16 | 0 × 0 | Used for testing internal registers. This |
| | | | register is meant for debugging. |
| CP_KEY_HI | 31:0 | 0 × 0 | |
| CP_KEY_LO | 31:0 | 0 × 0 | |
| PUBLIC_KEY_HI | 23:0 | 0 × 0 | |
| PUBLIC_KEY_LO | 31:0 | 0 × 0 | |

As described in Table 1, several registers may be used for controlling various encryption components, such as through DES decryptor 521, of digital video decoder 510. For example, a TD_PODCP_KEY_PAIR_{—}31_{—}0 register may be used to select a destination device (video, audio or auxiliary) for accessing public or copy protection key registers. A BYPASS_PODCP register may be used for enabling DES decryptor 521. Various control and status registers of DES decryptor 521 may also be provided. A KE_RESET control register may be used to reset the key exchange process, such as in the case where data errors have force the DES decryptor 521 to lose synchronization. A DATA_IN_OVERRUN status register indicates data input to DES decryptor 521 has overrun. If the overrun is ignored, data corruption may occur. Similarly, a DATA_OUT_OVERRUN status register indicates data output from DES decryptor 521 has led to overrun. A CP_KEY_EXCHANGE control register may be used to select a type of copy protection key exchange which will be performed between digital video decoder 510 and a CPU of a system in which digital video decoder 510 is interfaced with. Registers CP_KEY_HI and CP_KEY_LO may be used to indicated the most and lest significant DWORD of the copy protection key, respectively. Similarly, registers PUBLIC_KEY_HI and PUBLIC_KEY_LO may be used to represent the most and least significant DWORDS of the public key, respectively, when using a Diffie-Hellman copy protection key exchange scheme. While specific registers have been described herein, Table 1 is only used to describe registers for a specific embodiment of the present invention and it should be appreciated that other forms of registers may be used without departing from the scope of the present invention.

The systems described herein may be part of an information handling system. The term “information handling system” refers to any system that is capable of processing information or transferring information from one source to another. An information handling system may be a single device, such as a computer, a personal digital assistant (PDA), a hand held computing device, a cable set-top box, an Internet capable device, such as a cellular phone, and the like. Alternatively, an information handling system may refer to a collection of such devices. It should be appreciated that the system described herein has the advantage of protecting video data for transfer over an exposed data bus while providing a flexible system for upgrading to new copy protection standards.

In the preceding detailed description of the embodiments, reference has been made to the accompanying drawings which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method comprising the steps of:
receiving a protected data stream, wherein the protected data stream is scrambled using a first encryption scheme;
decoding the protected data stream using the first encryption scheme to generate an unscrambled data stream;
scrambling the unscrambled data stream using a second encryption scheme to generate a re-scrambled data stream, wherein the second encryption scheme is different from the first encryption scheme; and
providing the re-scrambled data stream to a stream decoder, through an exposed data bus, wherein the stream decoder decodes the re-scrambled data stream according to the second encryption scheme.

2. The method as in claim 1, wherein the protected data stream includes a multimedia transport stream.

3. The method as in claim 1, wherein the second encryption scheme includes a data encryption standard encryption scheme.

4. The method as in claim 1, wherein the steps of receiving the protected data stream and decoding the protected data stream are performed through a network interface module.

5. The method as in claim 4, wherein the protected data stream includes one of: a digital satellite data stream, a terrestrial data stream, or a cable data stream.

6. The method as in claim 4, wherein the network interface module is further used to perform the step of scrambling the unscrambled data stream.

7. The method as in claim 4, further including the step of storing the unscrambled data stream in memory, wherein the step of storing the unscrambled data stream in memory is performed through the network interface module.

8. The method as in claim 7, wherein the step of scrambling the unscrambled data stream is performed through a central processing unit.

9. The method as in claim 1, wherein the unscrambled data stream is passed through a local bus, wherein the local bus is unexposed to external probing.

10. The method as in claim 9, wherein the exposed data bus and the unexposed data bus are connected through a bus bridge component.

11. The method as in claim 1, wherein the exposed data bus includes a peripheral component interconnect bus.

12. A system comprising:
a local data bus having an input/output buffer;
a data processor having an input/output buffer coupled to the input/output buffer of the local data bus, said data processor to scramble an unprotected data stream stored in memory to generate a re-encrypted data stream;
a memory controller having:
a first input/output buffer coupled to the input/output buffer of the local data bus;
a second input/output buffer coupled to an input/output buffer of said memory;
said memory having an input/output buffer coupled to the input/output buffer of said memory controller;
a network interface module, having an input/output buffer coupled to the input/output buffer of the local data bus, said network interface module to:
receive a protected data stream, wherein said protected data stream is scrambled using a first encryption scheme;
unscramble the protected data stream using said first encryption scheme to generate said unprotected data stream;
store said unprotected data stream in said memory;
a bus bridge having a first input/output buffer coupled to the input/output buffer of the local data bus and a second input/output buffer coupled to the input/output buffer of a peripheral data bus, said bus bridge to handle data transfers between components coupled to the local data bus and components coupled to the peripheral data bus;
a peripheral data bus having a first input/output buffer coupled to the input/output buffer of the bus bridge and a second input/output buffer coupled to the input/output buffer of a data decoder;
a data decoder having an input/output buffer coupled to the input/output buffer of the peripheral data bus, said data decoder to:
unscramble said re-encrypted data stream; and
processing said data stream to generate multimedia data.

13. The system as in claim 12, wherein said protected data stream includes one of: a terrestrial television transport stream, a satellite television transport stream, or a cable television transport stream.

14. The system as in claim 12, wherein said local bus is protected from external probing.

15. The system as in claim 12, wherein said second encryption scheme includes a data encryption standard encryption scheme.

16. The system as in claim 12, wherein said data decoder includes a Motion Pictures Experts Group video decoder.

17. The system as in claim 12, wherein said data decoder includes a host bus interface unit for communicating with said peripheral data bus.

18. The system as in claim 17, wherein said host bus interface unit is used to perform address re-mapping functions.

19. The system as in claim 12, further including an analog video decoder to:
receive analog video signals; and
process said analog video signals to generate video data.

20. The system as in claim 19, wherein said video decoder is capable of providing video data associated with both analog video signals and digital video data.

21. The system as in claim 19, wherein said video decoder is capable of processing vertical blanking interval data.

22. The system as in claim 19, wherein said analog video decoder is capable of providing video to an analog television display.

23. The system as in claim 12, wherein said video decoder is capable of providing picture-in-picture video to display analog video data and digital video data concurrently.

24. The system as in claim 12, wherein said video decoder is capable of providing multimedia data to a high definition television for display.

25. The system as in claim 12, wherein unscrambling performed through said video decoder is handled through sets of registers.

26. A system comprising:
a data stream receiver to:
receive a protected data stream;
unscramble said protected data stream to generate an unprotected data stream;
scramble said protected data stream to generate a re-encrypted data stream;
a decoder to:
receive said re-encrypted data stream;
unscramble said re-encrypted data stream to generate an unscrambled data stream;
process said unscrambled data stream to generate multimedia data.

27. The system as in claim 26, wherein said protected data stream includes a transport stream.

28. The system as in claim 26, wherein said data stream receiver includes a network interface module.

29. The system as in claim 28, wherein said network interface module is capable of receiving one of terrestrial television transport streams, satellite television transport streams, and cable television transport streams.

30. The system as in claim 28, wherein said network interface module stores data associated with the re-encrypted data stream in memory.

31. The system as in claim 30, wherein said re-encrypted data stream is transferred from memory to said video decoder through a peripheral data bus.

32. The system as in claim 26, wherein said data stream receiver includes a point of deployment module.

33. The system as in claim 26, wherein said video decoder includes a Motion Pictures Experts Group video decoder.
